(19) United States
(12) Patent Application Publication
(10) Pub. No.: US 2026/0188952 A1
(43) Pub. Date: Jul. 2, 2026

(54) SELF-LOCKING POWER PLUG

(71) Applicant: YFC-BONEAGLE ELECTRIC CO., LTD., Taoyuan City (TW)

(72) Inventors: Sheng-Cheng SHEN, Taoyuan City (TW); Qing CHEN, Wuxi (CN); Yahong XU, Wuxi (CN)

(21) Appl. No.: 19/037,094

(22) Filed: Jan. 25, 2025

(30) Foreign Application Priority Data
Dec. 27, 2024 (TW) 113214341

(51) Int. Cl. H01R 13/639; H01R 13/187; H01R 13/633; H01R 24/20

(52) U.S. Cl. CPC H01R 13/639; H01R 13/187; H01R 13/6335; H01R 24/20

(57) ABSTRACT

A self-locking power plug includes an insulating seat, conductors, a locking plate, a slider, and an elastic element. The insulating seat includes a mating surface and defines an insertion direction toward the mating surface. A track is provided in the insulating seat parallel to the insertion direction, and first, second, and third channels exposing the conductors and opening onto the mating surface are formed within the insulating seat. The locking plate is placed inside the insulating seat and transversely extends across a longitudinal direction of the first channel. The slider is movable along the track between a released position and a locked position and drives the locking plate to rotate. The elastic element abuts against the insulating seat and the slider. At the released position, the locking plate is perpendicular to the first channel. At the locked position, the locking plate is inclined relative to the first channel.

### BACKGROUND OF THE DISCLOSURE

### Technical Field

The present disclosure relates to a power connection device, and more particularly, to a self-locking power plug that is securely plugged and easy to unplug.

### Description of Related Art

Power plugs are commonly used power connection devices for general electrical appliances. After a power plug is plugged into an outlet, it relies solely on the clamping force of the conductive copper pieces within the outlet to prevent it from falling out. Due to the limited clamping force of the copper pieces, if the power cord is accidentally pulled by an external force, the power plug is likely to fall out, causing power interruption. In addition, power plugs are used to transmit high-voltage current, and their loosening may cause the risk of electric shock. Therefore, how to make the plug able to be stably plugged into the socket hole and not easily loosen due to external force is a problem to be solved in this technical field.

To address these issues, the inventor of this disclosure has dedicated extensive research and applied relevant principles to overcome the aforementioned challenges.

### SUMMARY OF THE DISCLOSURE

The present disclosure provides a self-locking power plug that is securely plugged and easy to unplug.

The present disclosure provides a self-locking power plug for mating with an electrical outlet. The electrical outlet includes an outlet body and a plurality of conductive pins, the outlet body includes a mating groove, the conductive pins protrude in the mating groove. The self-locking power plug includes: an insulating seat, a plurality of conductors, a locking plate, a slider, and an elastic element. The insulating seat includes a mating surface and defines an insertion direction toward the mating surface, wherein a track is defined within the insulating seat parallel to the insertion direction, and a first channel, a second channel, and a third channel communicating with the mating surface are defined within the insulating seat parallel to the insertion direction. The conductors are embedded in the insulating seat and respectively exposed from the first channel, the second channel, and the third channel. The locking plate is disposed inside the insulating seat and transversely extends across a longitudinal direction of the first channel, wherein the locking plate is provided with a through-hole, a fixed side, and a movable side opposite the fixed side, the fixed side is positioned on the insulating seat, and the movable side is movably disposed between the second channel and the third channel. The slider is disposed in the track and movable along the track between a released position and a locked position, wherein the slider is engaged with the movable side of the locking plate and configured to drive the locking plate to rotate, the slider includes a handle, and the handle extends out of the insulating seat. The elastic element is disposed in the insulating seat and respectively abuts against the insulating seat and the slider to preload a force on the slider in a direction opposite to the insertion direction and toward the locked position. When the slider is located at the released position, the locking plate is perpendicular to the longitudinal direction of the first channel to allow one of the conductive pins to move longitudinally in the first channel. When the slider is located at the locked position, the slider drives the movable side of the locking plate to cause rotation of the locking plate, and the through-hole is rotated and inclined relative to the longitudinal direction of the first channel to a position where an inner edge of the through-hole is engaged with a side edge of the conductive pin in the first channel.

When the self-locking power plug is inserted into the electrical outlet, the conductive pin corresponding to the first channel abuts against and pushes the movable side of the locking plate to make the locking plate rotate. At the same time, the slider moves from the locked position to the released position to allow the self-locking power plug to be further inserted into the electrical outlet. When the self-locking power plug is inserted, the conductive pin stops pushing the locking plate, and the elastic element pushes the slider toward the locked position. The locking plate rotates until the inner edge of the through-hole is engaged with the side edge of the conductive pin in the first channel and stops. Therefore, the locking plate locks the corresponding conductive pin so that the self-locking power plug is prevented from being withdrawn from the electrical outlet.

When a user wants to remove the self-locking power plug from the electrical outlet, the user may grip the handle and pull the self-locking power plug to move the slider toward the released position. The slider drives the locking plate to swing so that the through-hole of the locking plate is perpendicular to the longitudinal direction of the first channel to allow the conductive pin in the first channel to move longitudinally. Therefore, the self-locking power plug may continue to be pulled and unplugged from the electrical outlet.

### BRIEF DESCRIPTION OF THE DRAWINGS

FIG. 1 is an exploded perspective view of a self-locking power plug according to an embodiment of the present disclosure.

FIG. 2 is another exploded perspective view of the self-locking power plug according to an embodiment of the present disclosure.

FIG. 3 is a perspective view of the self-locking power plug according to an embodiment of the present disclosure.

FIG. 4 is another perspective view of the self-locking power plug according to an embodiment of the present disclosure.

FIG. 5 is still another perspective view of the self-locking power plug according to an embodiment of the present disclosure.

FIG. 6 is a schematic view of a power connection device according to an embodiment of the present disclosure with a slider in a locked position.

FIGS. 7 to 8 are schematic views of a plugging operation of the power connection device according to an embodiment of the present disclosure.

FIG. 9 is a schematic view of the power connection device according to an embodiment of the present disclosure with the slider in a released position.

### DETAILED DESCRIPTION

The detailed description and technical content of the present disclosure are described below in conjunction with the drawings. However, the accompanying drawings are for illustrative purposes only and are not intended to limit this disclosure.

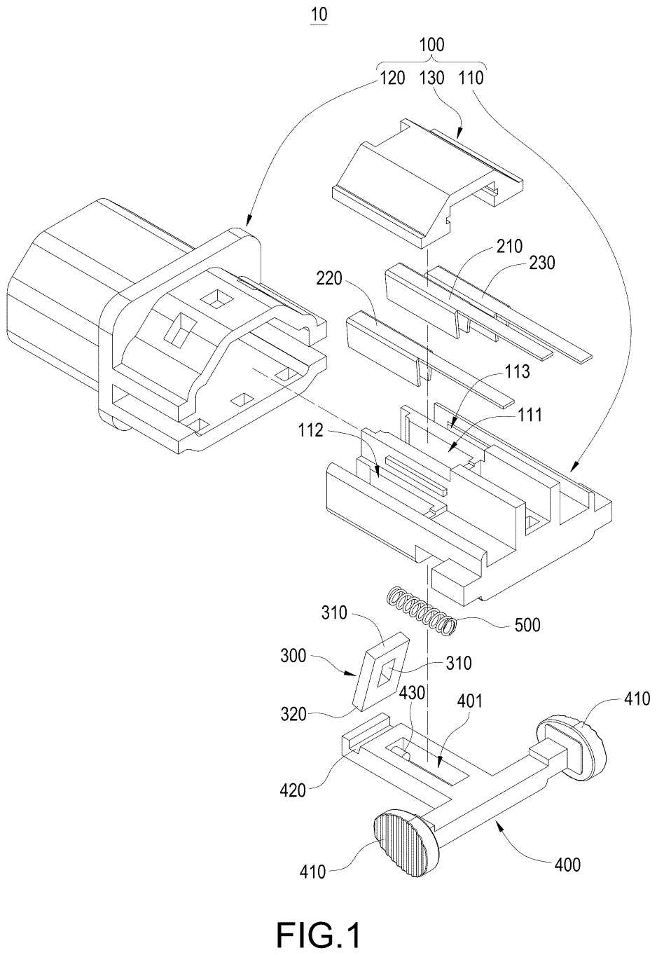

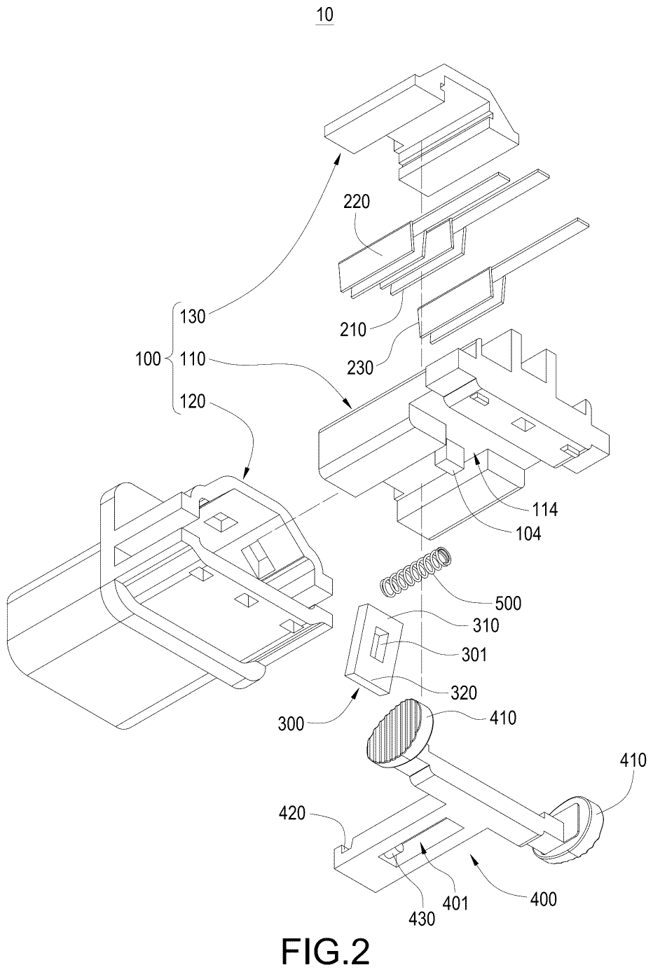

FIG. 1 is an exploded perspective view of a self-locking power plug 10 according to an embodiment of the present disclosure. FIG. 2 is another exploded perspective view of the self-locking power plug 10 according to an embodiment of the present disclosure. Referring to FIGS. 1 to 2, the self-locking power plug 10 of this disclosure includes an insulating seat 100, a plurality of conductors 210, 220, 230, a locking plate 300, a slider 400, and an elastic element 500.

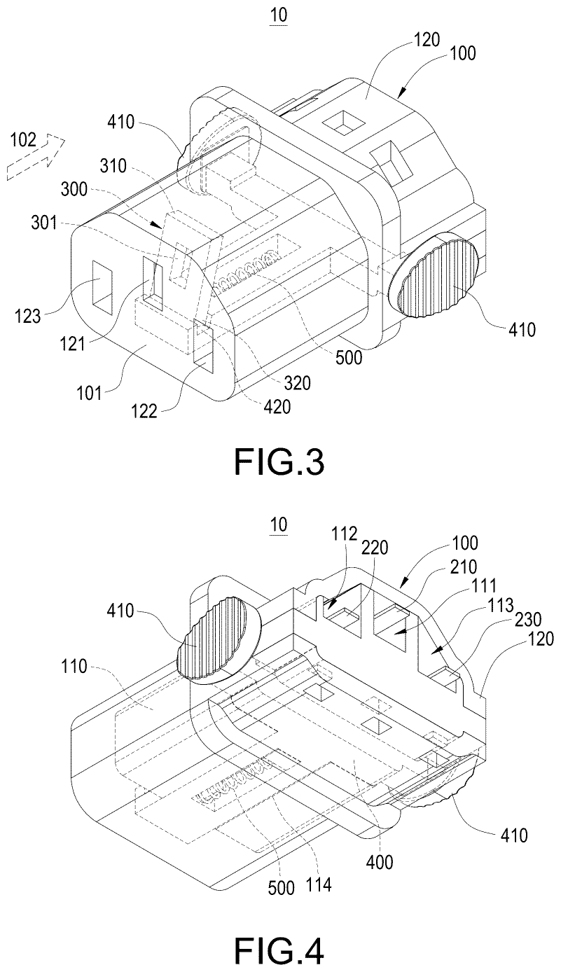

FIG. 3 is a perspective view of the self-locking power plug 10 according to an embodiment of the present disclosure. Referring to FIG. 3, the insulating seat 100 has a mating surface 101, and an insertion direction 102 is defined in the insulating seat 100. Specifically, the insertion direction 102 is defined as being perpendicularly toward the mating surface 101.

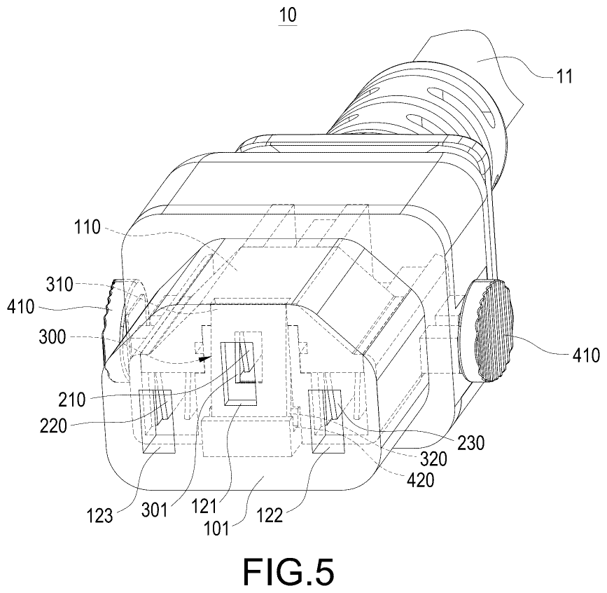

FIG. 4 is another perspective view of the self-locking power plug 10 according to an embodiment of the present disclosure. Referring to FIGS. 1 to 4, a track 114, a first channel 111, a second channel 112, and a third channel 113 are provided within the insulating seat 100. The first channel 111, the second channel 112, and the third channel 113 communicate with the mating surface 101. Specifically, the insulating seat 100 includes a body 110 and a housing 120. The body 110 is disposed inside the housing 120. The first channel 111, the second channel 112, and the third channel 113 are defined in the body 110. The mating surface 101 is formed on the housing 120. A plurality of jacks 121, 122, 123 are formed on the mating surface 101, and longitudinally aligned with the first channel 111, the second channel 112, and the third channel 113, thereby allowing the first channel 111, the second channel 112, and the third channel 113 to communicate with the mating surface 101. The track 114 is disposed on one side of the body 110, the track 114 is parallel to the insertion direction 102, and a block 104 protrudes within the track 114. The first channel 111, the second channel 112, and the third channel 113 are disposed on the other side of the body 110 opposite to the track 114, and the first channel 111, the second channel 112, and the third channel 113 are all opened on one side.

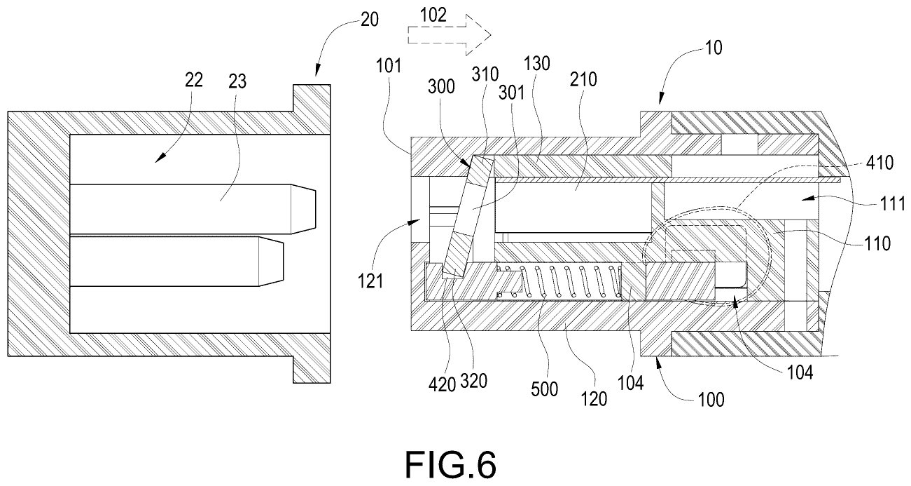

The conductors 210, 220, 230 are embedded in the insulating seat 100, and the conductors 210, 220, 230 are respectively received in the first channel 111, the second channel 112, and the third channel 113, so that the conductors 210, 220, 230 are respectively exposed from the first channel 111, the second channel 112, and the third channel 113. In this embodiment, the conductors 210, 220, 230 are inserted into the first channel 111, the second channel 112, and the third channel 113 through the open side of the first channel 111, the second channel 112, and the third channel 113, respectively. Furthermore, the aforementioned insulating seat 100 further includes a pressing block 130. The pressing block 130 is engaged with the body 110 and presses and fixes the conductors 210, 220, 230 in the first channel 111, the second channel 112, and the third channel 113, respectively. FIG. 5 is still another perspective view of the self-locking power plug 10 according to an embodiment of the present disclosure. Referring to FIG. 5, the conductors 210, 220, 230 are further connected to a wire.

Referring to FIGS. 1 to 3, the locking plate 300 is disposed inside the insulating seat 100, and the locking plate 300 is disposed between one end of the first channel 111 and the jack 121 corresponding to the first channel 111 to transversely extend across a longitudinal direction of the first channel 111. The locking plate 300 is provided with a through-hole 301, a fixed side 310, and a movable side 320 opposite to the fixed side 310. The fixed side 310 of the locking plate 300 is positioned on the insulating seat 100, and the movable side 320 of the locking plate 300 is movably disposed between the second channel 112 and the third channel 113, and the movable side 320 of the locking plate 300 is longitudinally aligned with the track 114.

As shown in FIGS. 2 to 4, the slider 400 fits into the track 114 and is confined by the housing 120. The housing 120 keeps the slider 400 within the track 114, allowing the slider 400 to slide along. The slider 400 includes a handle 410, and the handle 410 extends out of the insulating seat 100 for a user to push the slider 400. The slider 400 is provided with a hook 420 that is engaged with the movable side 320 of the locking plate 300 to drive the locking plate 300 rotate. The slider 400 is provided with a longitudinal slot 401. When the slider 400 is disposed in the track 114, the longitudinal slot 401 extends along a longitudinal direction of the track 114, and the block 104 in the track 114 is received in the longitudinal slot 401 and is disposed corresponding to one end of the longitudinal slot 401 away from the mating surface 101. A longitudinal pin 430 is also provided protruding within the end of the longitudinal slot 401 adjacent to the mating surface 101, and the longitudinal pin 430 extends along the longitudinal direction of the track 114.

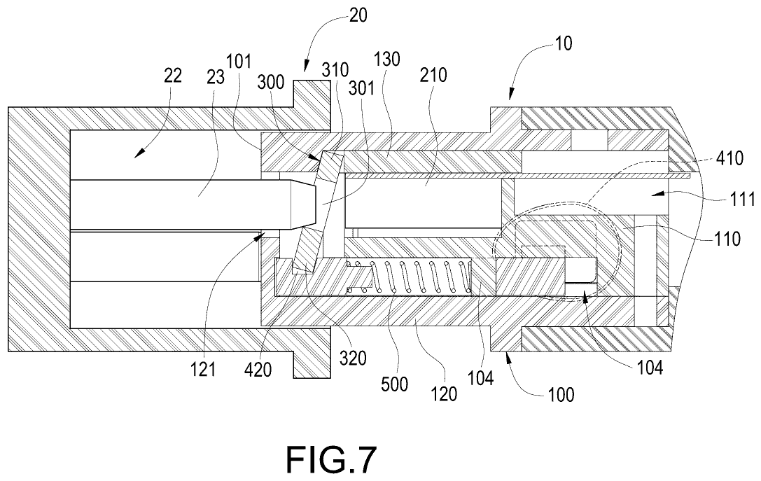

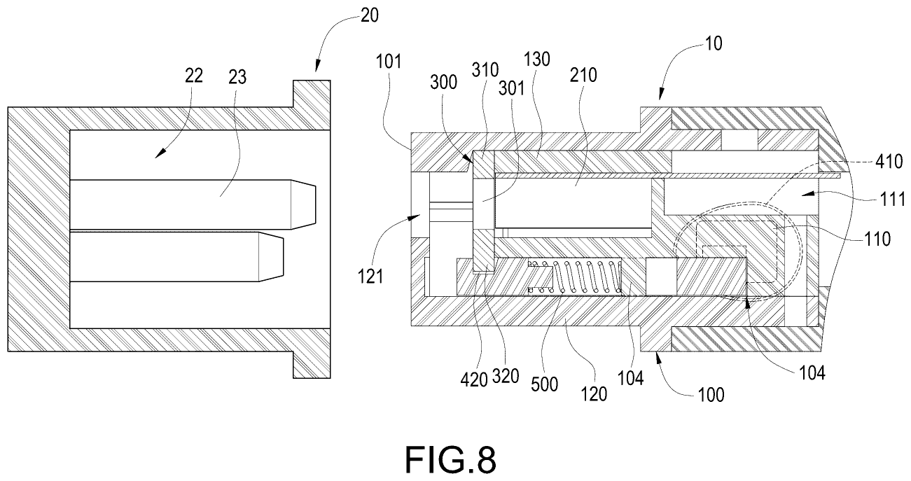

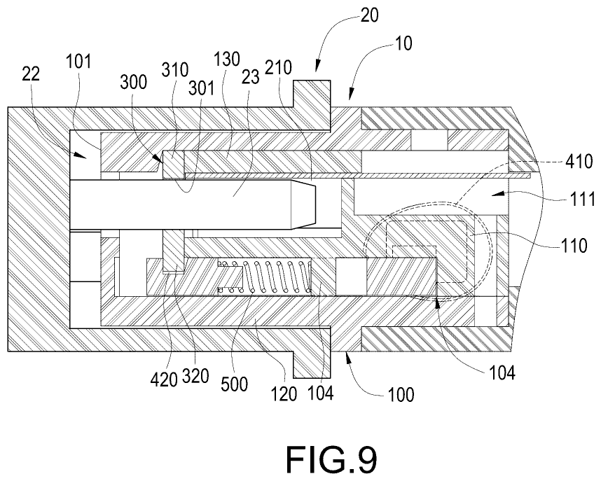

FIG. 6 is a schematic view of a power connection device according to an embodiment of the present disclosure with the slider 400 in a locked position; FIGS. 7 to 8 are schematic views of a plugging operation of the power connection device according to an embodiment of the present disclosure; FIG. 9 is a schematic view of the power connection device according to an embodiment of the present disclosure with the slider 400 in a released position.

The slider 400 is disposed movably along the track 114 between the locked position adjacent to the mating surface 101 as shown in FIG. 6 and the released position away from the mating surface 101 as shown in FIG. 9. Referring to FIGS. 1 to 4, the elastic element 500 is disposed in the insulating seat 100 and abuts against the insulating seat 100 and the slider 400 respectively to preload a force on the slider 400 in a direction opposite to the insertion direction 102 and toward the locked position. Referring to FIG. 6, specifically, the elastic element 500 is received in the longitudinal slot 401 and abuts against the block 104 and one end of the longitudinal slot 401 adjacent to the mating surface 101 respectively, and the longitudinal pin 430 is inserted into the elastic element 500 for fixing. Therefore, the elastic element 500 pushes the slider 400 toward the locked position with the block 104 as a support. As shown in FIG. 6, when the slider 400 is located at the locked position, the locking plate 300 is disposed inclined relative to the longitudinal direction of the first channel 111. As shown in FIG. 9, when the slider 400 is located at the released position, the locking plate 300 is perpendicular to the longitudinal direction of the first channel 111.

As shown in FIG. 6, the present disclosure provides a power connection device, including the aforementioned self-locking power plug 10 and an electrical outlet 20. The electrical outlet 20 includes an outlet body 21 and a plurality of conductive pins 23 corresponding to the conductors 210, 220, 230, and the outlet body 21 includes a mating groove 22, and the conductive pins 23 protrude in the mating groove 22.

Referring to FIGS. 7 and 8, the mating groove 22 is used to receive the insulating seat 100, and the conductive pins 23 respectively pass through the jacks 121, 122, 123 and are inserted into the first channel 111, the second channel 112, and the third channel 113 and respectively connected with the conductors 210, 220, 230.

Referring to FIG. 7, when the insulating seat 100 is inserted into the mating groove 22, the conductive pin 23 corresponding to the first channel 111 abuts against and pushes the movable side 320 of the locking plate 300 to make the locking plate 300 swing to be perpendicular to the longitudinal direction of the first channel 111, and the slider 400 simultaneously moves from the locked position to the released position. At this time, the conductive pin 23 may pass through the through-hole 301 of the locking plate 300 and be inserted into the first channel 111 to allow the other conductive pins 23 to be respectively inserted into the corresponding second channel 112 and third channel 113 when the insulating seat 100 is further inserted into the mating groove 22.

Referring to FIG. 8, when the insulating seat 100 stops being inserted into the mating groove 22, the conductive pin 23 stops pushing the locking plate 300, and the elastic element 500 pushes the slider 400 toward the locked position. When the slider 400 moves toward the locked position, the movable side 320 of the locking plate 300 is driven by the slider 400 to cause the locking plate 300 to rotate, and the through-hole 301 is rotated and inclined relative to the longitudinal direction of the first channel 111 so that a projected area of the cross-section of the through-hole 301 in the longitudinal direction of the first channel 111 gradually shrinks. The locking plate 300 rotates to a position where an inner edge of the through-hole 301 is engaged with a side edge of the conductive pin 23 in the first channel 111 and stops. Therefore, the locking plate 300 locks the corresponding conductive pin 23 so that the self-locking power plug 10 is prevented from being withdrawn from the electrical outlet 20.

As shown in FIG. 9, when it is desired to remove the self-locking power plug 10 from the electrical outlet 20, the user may grip the handle 410 and pull the self-locking power plug 10 to move the slider 400 toward the released position. The slider 400 drives the locking plate 300 to rotate so that the through-hole 301 of the locking plate 300 is perpendicular to the longitudinal direction of the first channel 111 to allow the conductive pin 23 in the first channel 111 to move longitudinally. Therefore, the self-locking power plug 10 may continue to be pulled and unplugged from the electrical outlet 20.

The foregoing is only a preferred embodiment of the present disclosure and is not intended to limit the protection scope of the present disclosure. Other equivalent variations that are based on the spirit of the present disclosure shall fall within the scope of the present disclosure.

What is claimed is:

1. A self-locking power plug, for mating with an electrical outlet, the electrical outlet comprising an outlet body and a plurality of conductive pins, the outlet body comprising a mating groove, the conductive pins disposed protrusively in the mating groove, the self-locking power plug comprising:
an insulating seat, comprising a mating surface, an insertion direction defined toward the mating surface, a track disposed therein parallel to the insertion direction, and a first channel, a second channel, and a third channel defined therein parallel to the insertion direction and communicating with the mating surface;
a plurality of conductors, disposed in the insulating seat, and respectively exposed from the first channel, the second channel, and the third channel;
a locking plate, disposed in the insulating seat and transversely extending across a longitudinal direction of the first channel, comprising a through-hole, a fixed side, and a movable side opposite to the fixed side, the fixed side positioned on the insulating seat, and the movable side movably disposed between the second channel and the third channel;
a slider, disposed movably along the track between a released position and a locked position, engaged with the movable side of the locking plate to drive the locking plate to rotate, and comprising a handle extending out of the insulating seat; and
an elastic element, disposed in the insulating seat and respectively abutting against the insulating seat and the slider to preload a force on the slider in a direction opposite to the insertion direction and toward the locked position,
wherein when the slider is located at the released position, the locking plate is perpendicular to the longitudinal direction of the first channel to allow one of the conductive pins to move longitudinally in the first channel;
wherein when the slider is located at the locked position, the locking plate is disposed inclined relative to the longitudinal direction of the first channel;
wherein when the insulating seat is inserted in the mating groove and the conductive pins are respectively inserted into the first channel, the second channel, and the third channel and respectively mated with the conductors, the slider moves toward the locked position to drive the movable side of the locking plate to make the locking plate rotate, and the through-hole is rotated and inclined relative to the longitudinal direction of the first channel to a position where an inner edge of the through-hole is engaged with a side edge of the conductive pin in the first channel.

2. The self-locking power plug according to claim 1, wherein the insulating seat comprises a body and a housing, the body is disposed in the housing, the first channel, the second channel, and the third channel are defined in the body, the mating surface is located on the housing, and a plurality of jacks are defined on the mating surface and longitudinally aligned with the first channel, the second channel, and the third channel.

3. The self-locking power plug according to claim 2, wherein the locking plate is disposed between one end of the first channel and one of the jacks corresponding to the first channel, and the movable side of the locking plate is longitudinally aligned with the track.

4. The self-locking power plug according to claim 2, wherein the slider is confined within the track by the housing.

5. The self-locking power plug according to claim 2, wherein the track is located on one side of the body, and the first channel, the second channel, and the third channel are located on another side of the body opposite to the track.

6. The self-locking power plug according to claim 5, wherein the first channel, the second channel, and the third channel are all opened on one side, and the conductors are respectively received in the first channel, the second channel, and the third channel.

7. The self-locking power plug according to claim 6, wherein the insulating seat further comprises a pressing block engaged with the body and pressing and fixing the conductors in the first channel, the second channel, and the third channel, respectively.

8. The self-locking power plug according to claim 1, wherein the slider comprises a longitudinal slot and a block disposed protrusively in the track, the block is received in the longitudinal slot and disposed corresponding to one end of the longitudinal slot, and the elastic element is received in the longitudinal slot and respectively abuts against the block and another end of the longitudinal slot.

9. The self-locking power plug according to claim 8, wherein a longitudinal pin is disposed protrusively in the longitudinal slot, and the longitudinal pin is inserted in the elastic element.

10. The self-locking power plug according to claim 1, wherein the slider comprises a hook engaged with the movable side of the locking plate.
